(19) United States
(12) Patent Application Publication
(10) Pub. No.: US 2011/0107534 A1
(43) Pub. Date: May 12, 2011

(54) Broken or clogged aerosol dispenser recovery tool

(76) Inventor: Michael Eugene Hoctor, Phoenix, AZ (US)

(21) Appl. No.: 12/925,205

(22) Filed: Oct. 15, 2010

Related U.S. Application Data
(60) Provisional application No. 61/279,205, filed on Oct. 19, 2009.

(51) Int. Cl. B08B 9/00

(52) U.S. Cl. 15/104.05

(57) ABSTRACT

An Aerosol salvage tool used for tapping and dispensing, for their intended use, aerosol products that have had their original dispensing actuators or nozzles broken or disabled. This tool comprises two separately formed handles pivotally attached to each other which form an adjustable circular containment for an aerosol container. This allows for multiple size aerosol containers to fit within the tool. One of the handles has a container piercing member mounted thereon. As the handles are pivoted towards each other the inside diameter closes in engaging the piercing member and aerosol container thereby piercing the container allowing it's content to flow through the member into it's spray actuator and nozzle. Simultaneously as the handles are drawn toward each other a staged locking devise and safety lock engages holding the tool in place on the container thereby preventing the tool from being released accidentally.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

For many years aerosols have been an integral part of most everyone's daily lives for the delivery and dispensing of many products such as deodorants, hair sprays, medications, air fresheners, cleaners, lubricants, paints, insecticides, and many other products that are used daily all over the world. Since the first aerosol product dispensers were produced they have been plagued with various negative conditions which in most cases render the dispenser and it's product unusable. The most common of these conditions is a clogged spray actuator and/or nozzle, this condition is commonly caused by periods of storage or non-use. Another common cause for a disabled aerosol product is, many aerosol dispensers get accidentally dropped or mishandled which can cause the spray actuator and/or nozzle to break disabling it. Probably the most common problem is when the spray nozzle itself gets lost or misplaced, this condition only renders the product unusable when a suitable nozzle cannot be found to replace the lost or misplaced nozzle.

Aerosol products are packaged and marketed in convenient and economical cylindrical shaped metal vessels. These vessels come in many different sizes in diameter, height, and volume. Aerosols are typically pressurized with some form of gas or propellant that pushes it's content up through a dip tube into a spray actuator and spray nozzle, that when depressed by it's operator, delivers the content at a rate determined by the products application and/or use.

This invention was conceived by an inventor who has worked in the automotive industry for over 25 years. During that time he has seen an incredible amount of aerosol products being thrown away because their spray nozzles and/or actuators became broken or clogged. The problem was not only the wasted product, but the time involved in replacing the products was time consuming and costly. It also seemed a huge waste of resources sending unused aerosol products to a landfill, not to mention most aerosol products are toxic and/or have a negative environmental impact.

It is clear this invention will have a positive impact economically and environmentally by allowing for the intended use of aerosol products saving in resources, and preventing these products from polluting landfills and/or other such waste containments. Clearly this invention is a tool that will help to solve these problems in a positive way.

(2) Description of the Related Art

There are many inventions with patents issued for aerosol container evacuation for safe disposal. Many of these patents appear to be for large scale or multiple aerosol container processing (examples include: O'Neil U.S. Pat. No. 5,322,093, Cound U.S. Pat. No. 4,459,906, Gonzalez-Miller U.S. Pat. No. 5,174,344, Nash U.S. Pat. No. 5,088,526) which appear impractical because of the huge variety of aerosol products that can't or shouldn't be mixed during the evacuation process. There are also many patents issued for single container evacuation for disposal (examples include: Rubenic U.S. Pat. No. 6,481,470, Iglesis U.S. Pat. No. 4,428,510). These inventions address the evacuation and disposal issue, but none that allows for the consumer to immediately use the product for it's intended purpose. I was able to find two patents for pressurized vessel piercing tools, (Robertson U.S. Pat. No. 4,852,769, and Dudley U.S. Pat. No. RE41,263), both of which are for piercing and dispensing automotive Freon cans. The first one Robertson, is the tool the inventor used to make a working prototype shown in FIG. 1 of the drawings. Both of these patents are currently manufactured and sold, but neither are used or marketed for the salvage and use of disabled aerosol products.

Many of the classifications and subclasses provided for by the USPTO describe or can be applied either all or in part to the features found in this invention. I find the following U.S. patent classifications applicable to this invention:

30/443 Device wherein the cutting element includes at least one sharp cutting edge and is adapted to pierce through the wall of the container in a single stroke.
30/363 Device comprising a pair of cooperating tool carriers or tool drivers connected to each other so that one carrier or driver may be swung about a fixed axis relative to the other, each of the carriers or drivers being adapted to be grasped by the operator and moved relative to the other so as to effect relative movement of the tools toward each other.
30/448 Device including a base and structure for holding the container on the base against the force of gravity while the container is being opened.
81/300, this tool has two relatively movable work engaging jaws, and two relatively movable hand gripped handles, and joint mechanism interconnecting said jaws and said handles whereby manipulative movement of the handles with respect to each other effects relative movement of the jaws.
81/304, this tool includes two handles which are manipulated for movement with respect to each other to actuate the jaws
81/312, the jaw surfaces are generally parallel to each other and separate from each other along a line substantially normal to the surfaces.
81/315, This tool includes means for latching the handles against pivotal movement with respect to each other and means for moving the jaws with respect to each other while the handles are latched.
81/316, This tool includes means for latching the handles in any one of a number of desired handle relationships.
81/319, This tool includes means both for latching the jaws in a desired relationship and for disengaging the latch means.
81/320, This tool includes means both for latching the jaws in a desired relationship and for holding the latch means out of operative or latching position.
81/322, This tool includes additional resilient means, separate and apart from the handle biasing means, for maintaining latch interengagement.
81/323, This tool includes means for holding the jaws in the desired relationship and resilient means for biasing said holding means into jaw securing position.
81/324, This tool includes means for latching the jaws rigidly into desired relationship.
81/325, This tool includes means for latching the jaws in any one of a number of desired adjusted positions.
81/329, This tool includes means to restrain the jaws against movement away from the work engaged, which means does not restrict movement of the jaws towards the work.
81/330, Tools in which the restraining means is effective in predetermined jaw positions chosen by the operator.
81/338, This tool includes a rack connected to one handle or jaw mating with a pawl connected to the other handle or jaw.
81/348, This tools jaws are fulcrumed with respect to each other for pivotal movement to or from each other.
81/421 Tools including a separate work-engaging element fastened or secured to at least one jaw.
81/426 Tools in which each of the work-engaging jaw surfaces is recited as different from the other work-engaging surface(s).
137/318 Devices in which the connectable means carries a cutter or punch for making the opening in the closed system through which flow will occur. The aperture may be formed at the time the connection is placed, or subsequently by operation of means carried by the connectable means.
137/614.05 Systems in which actuation of one of the valves, flow controllers or closures is simultaneous with the joining or disconnecting of the flow path sections.
141/329 Filling apparatus which involve a penetrating or piercing means, which is supply means carried, receiver carried or a receiver adjunct means carried for piercing some part of the system to thereby establish a flow path between the supply means and the receiver.
141/348 Filling apparatus which includes supply attached means for engaging a receiver inlet-controlling means for opening the same.
222/5 Dispensers claimed in combinations with a punch or a cutter.
222/81 Dispensers in which at least one cutter or punch is designed to form a dispensing opening in the container which holds the material to be dispensed.
222/83 Dispensers having at least one cutter or punch mounted movably relative to other portions of the structure with which it is associated so that it may be moved relative to such associated structure to perform its cutting or punching operation.
222/83.5 Dispensers having a sleeve or rest into or on which the receptacle to be cut is placed.
222/89 Dispensers in which there is a nozzle associated with a cutter or punch, and in which there is means to secure the nozzle to the receptacle whose contents are to be dispensed.

### References Cited, U.S. Patent Documents

| | | |
|---|---|---|
| 3,438,656 | Apr. 15, 1969 | J. L. Fritch |
| 4,401,240 | Aug. 30, 1983 | Brack |
| 4,428,510 | Jan. 31, 1984 | Iglesias |
| 4,459,906 | Jul. 17, 1984 | Cound, et al. |
| 4,500,015 | Feb. 19, 1985 | Penney |
| 5,035,106 | Jul. 30, 1991 | Haase |
| 5,067,529 | Nov. 26, 1991 | Gonzalez-Miller, et al. |
| 5,088,526 | Feb. 18, 1992 | Nash |
| 5,163,585 | Nov. 17, 1992 | Campbell |
| 5,232,124 | Aug. 3, 1993 | Schneider, et al. |
| 5,265,762 | Nov. 30, 1993 | Campbell, et al. |
| 5,322,093 | Jun. 21, 1994 | O'Neil |
| 5,365,982 | Nov. 22, 1990 | O'Neill |
| 5,309,956 | May 10, 1994 | Hajma |
| 3,333,735 | Aug. 1, 1967 | Adasso |
| 5,271,437 | Dec. 21, 1993 | O'Brian |
| 5,086,814 | Feb. 11, 1992 | Sato |
| 4,349,054 | Sep. 14, 1982 | Chipman |
| 3,438,548 | Apr. 15, 1969 | Ceyba |
| 6,481,470 | Nov. 12, 2002 | Rubenic |
| RE41,263 | Apr. 27, 2010 | Dudley |
| 4,852,769 | Aug. 1, 1989 | Robertson, et al. |

### BRIEF SUMMARY OF THE INVENTION

The principles of this invention in accordance with the embodiment described, is a hand held tool which allows for the intended use of disabled aerosol products, providing a significant positive impact for the economy and environment.

This invention comprises of two pivotably attached handles that are urged by a spring to an open position, the receiver portion of one handle has an inward container piercing element and seal, opposite the piercing element and seal on the same handle is a receiver to accept an interchangeable spray actuator/nozzle, and interchangeable pressure pump. (this receiver could also simply be cast with an actuator and nozzle as part of the handle) Each handle has a grip portion and a circular aerosol container receiving portion. Each handle has elements that combine for a releasable co-acting locking devise, as the handles are squeezed toward each other the co-acting locking devise holds the tool in multiple closing positions. The releasable locking devise also has a spring urged safety locking lever to prevent the accidental release of an aerosol container.

Upon careful study of the detailed description and drawings of this invention any person of average skill in the art will realize the apparent objects, features, benefits, and advantages of this invention.

### BRIEF DESCRIPTION OF THE DRAWINGS

FIG. 1: Working Prototype—is a picture of a tool assembled by the inventor. This is an actual working prototype made with a spray actuator and nozzle, a few brass fittings, on a tap tool used for the installation of automotive Freon. This working prototype only fits one size diameter of an aerosol container 2⅝″, which is a very popular size fitting most aerosols including spray paints.

FIG. 2: Preferred Embodiment—is a drawing of the preferred embodiment.

FIG. 2a: Side View of the Invention—is a side view of the outer surfaces of the handles 13a, and 13b, showing a general placement for the hinge 10 at the top of handle 13a, and general placement of the male barbed connecter 19, on the outer receiving surface of handle 13b.

FIG. 3: Not Assigned

FIG. 4: Piercing Tube and Gasket—is a drawing showing the piercing tube 17, and gasket 18 that engages an aerosol container, and recess 49 for the gasket 18, which are located on the inner receiving surface 6 of handle 13b.

FIG. 5: Cut-away View of the Schrader Valve, Male Barbed Connector, and Piercing Tube—is a cut-away view of the piercing tube 17 and male barbed connector 19 as one piece with the Schrader valve 20 fitted within the male barbed connector 19.

FIG. 6: Replaceable Actuator/Nozzle Assembly 2—is a side view drawing of the replaceable spray actuator 30, and nozzle 22, component breakdown.

FIG. 6a: Opening View of Female Barb Connector—is a view into the opening or receiving end of the spray actuator/nozzle 2, or pump 3.

FIG. 7: Interchangeable Pump Attachment—a drawing of an optional pump used for pressurizing an aerosol container that has lost it's pressure but still retains usable content.

FIG. 8: Front View of Pawl—is a front view of the pawl 12, showing the anchor pin hole 34, pawl spring rest 35, rack opening 36, safety lock lever opening 43, and safety lock lever spindles 41.

FIG. 9: Side View of the Pawl—is a side view of the pawl 12, and safety lock lever 39.

FIG. 10: Safety Lock Lever with Pivot Points—is a side view of the safety lock lever 39, and it's pivot point hole(s) 42.

FIG. 11: Safety Lock Lever Return Spring—is a view of the safety lock lever return spring 40.

0—Receiver Opening for an Aerosol Container
1—All Elements Complete Tool (excluding attachments)
2—Complete Spray Attachment
3—Complete Pump Attachment
4—Opening in 19 for Schrader Valve
5—Outer Receiver Surface of Handle 13b
6—Inner Receiver Surface of Handle 13b
7—Inner Surface of Receiver Portion of Handle 13a
8—Outer Receiver Surface of Handle 13a
9—Female Barb Receiver
10—Pivoting Hinge for Handles (13a and 13b)
11—Adjustment Rack (fine toothed)
12—Pawl
13a—Handle (Pivoting)
13b—Handle (Piercing)
14—Pawl Tension Spring
15—Pawl Anchoring Pin
16—Handle Pivot Return Spring
17—Piercing Tube
18—Container Sealing Gasket
19—Male Barbed Connector
20—Schrader Valve
21—Actuator Valve
22—Spray Nozzle
23—Pump Plunger Return Spring
24—Reed Valve
25—Rubber Pressure Cup for Pump
26—Plunger Shaft
27—Schrader Valve Actuator
28—Pump Housing
29—Female Barb Connectors
30—Spray Actuator Housing
31—Female Barb Connector Release Points
32—Finger Grips for Actuator/Nozzle and Pump
33—Pump Shaft Thumb Rest
34—Pawl Anchor Pin Hole
35—Pawl Tension Spring Contact
36—Engagement Opening for Rack
37—Finger Lock Release Knob
38—Safety Lock Lever Opening
39—Safety Lock Lever
40—Safety Lock Lever Return Spring
41—Safety Lock Lever Pivoting Spindles
42—Safety Lock Lever Pivoting Holes
43—Safety Lock Lever Opening
44—Inside Surface of Handle 13a
45—Outer Surface of Handle 13a
46—Male Barb Connector Lip
47—Barbed Connector O-ring
48—Male Barbed Connector Taper
49—Gasket Recess

### DETAILED DESCRIPTION OF THE INVENTION

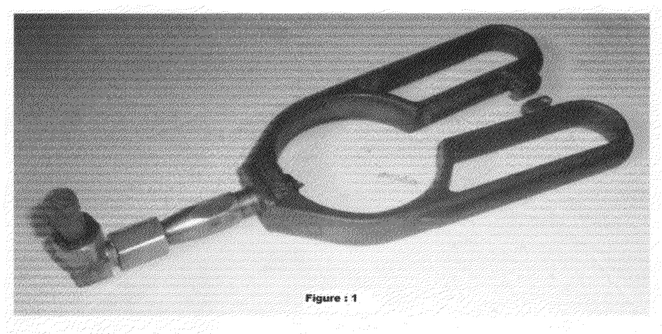

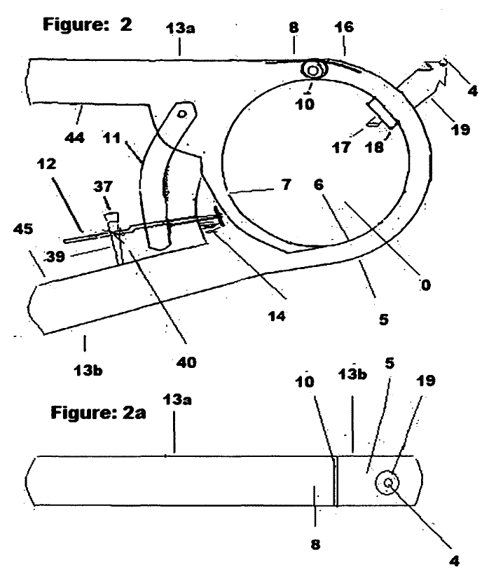

FIGS. 1 and 2, The photo and illustration for FIGS. 1 and 2 represent the inventors preferred embodiments for this invention.

FIG. 1, is a photograph of an actual working prototype assembled by the inventor as the need for this invention became apparent. Pictured is an automotive Freon “tap tool” with a few common pipe fittings and a spray actuator/nozzle, gathered and assembled by the inventor. This embodiment represents the idea of a simple tool cast in a one piece design that fit's a most common aerosol container diameter (2⅝″) which can be produced inexpensively as a disposable or reusable tool dependant on the care taken in use and/or variety of product it is used to dispense. It is to be understood that various embodiments of this invention may be utilized without departing from the scope and principles of this invention.

FIG. 2, represents a tool 1 that is diversely adjustable to fit any size aerosol container and has a receiver 19 that allows for placement or replacement of an actuator/nozzle 2 and/or interchangeable pump attachment 3 in case the need arises to use an aerosol product with content but void of propellant or pressure. This invention comprises of two generally symmetrical handles 13a,13b, formed with two generally semi-circular receiving surfaces 6,7, which pivot on a hinge 10 that joins the two handles 13a,13b, at the ends of the receiver portions 6,7, of the handles 13a,13b. Co-acting with the hinge 10 is a spring 16 that urges the handles 13a,13b apart upon release of the tool 1 from a closed position. Attached to the inside portion 44 of handle 13a is a fine toothed rack 11, that engages a pawl 12 attached to the inside portion 45 of the opposite handle 13b. At the top of the pawl 12 just below the receiver portion 6 of handle 13b is a pin 15 anchoring the pawl 12 through a hole 34, allowing the pawl 12 to pivot slightly on the pin 15, located at top of the pawl 12 just below the pin 15 is a pawl tension spring 14 that holds the pawl 12 engaged to the rack 11, thereby holding closed positions of the tool 1. Located on the pawl 12 just below the pawl tension spring 14 is a rack opening 36 which positions the rack 11, and allows for it's travel through the pawl 12, as the handles 13a,13b, are squeezed toward each other, the pawl tension spring 14 holds the pawl 12 engaged with the rack 11, as it clicks holding each closing adjustment as the receiver surfaces 6 and 7, close in onto the container. To release the tool 1 from it's lock positions the pawl 12 is simply pulled toward the inner surface 44 of handle 13b.

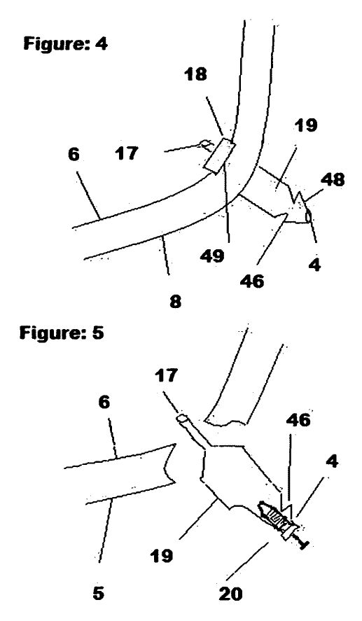

FIG. 2a, is a side view of the handle 13a side of the tool 1 standing on end. FIG. 2a also provides a view of the outer surface 5 of handle 13b giving a general idea for placement of the male barbed connector 19 in handle 13b, and a general idea for the placement of the hinge 10 that attaches handles 13a and 13b. Additionally provided in FIGS. 2 and 2a, are measurements for the disclosed embodiment to be considered a reference for the general size of this tool 1. Represented in FIG. 4, is a cut-away view of the receiver portion of handle 13b near the hinge 10. Projecting inward on the receiving surface 6 is a piercing tube 17. Recessed 49 slightly into the receiver surface 6 of handle 13b, and surrounding the piercing tube 17 is a container sealing gasket 18. For illustrative purposes the piercing tube is represented in the illustrations as hollow and needle shaped, and protruding from the gasket 18. Preferably the gasket 18 contacts the container surface just before or simultaneously with the piercing tube 17, thus preventing any leakage upon engagement of the tool 1. Part of and in continuation of the piercing tube 17 extending through the inner surface 6 and outer surface 5 of the receiver portion of handle 13b is a male barbed connector 19 which has a threaded opening 4 in the end opposite of the piercing tube 17. This threaded opening 4 is fitted with a Schrader valve 20. Those familiar in the art know a Schrader valve shuts off the flow of air, gases, or fluids and the like until the valve is actuated.

FIG. 5, is a cut-away view of the Schrader valve 20 in place in the threaded opening 4 of the male barbed connector 19. FIG. 5 also provides a cut-away view of the piercing tube 17 and male barbed connector 19 as a one piece member.

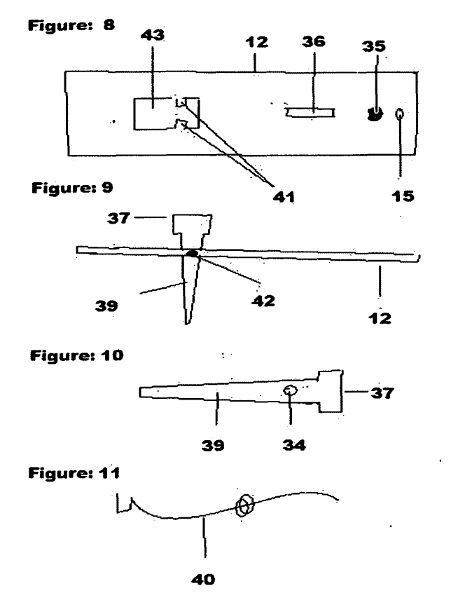

Represented in FIGS. 8-11 are the Safety Lock Features. Below the rack opening 36 in the pawl 12 is a safety lock lever opening 38, incorporated into this opening 38 are two spindles 41 that allow the safety lock lever 39 to pivot in and out of the locked position. Incorporated onto the safety lock lever 39 is a thumb or finger knob 37 to allow the operator to flip the lever 39 out of a locked position, which is held automatically into the locked position by the safety lock spring 40. On either side near the thumb knob 37 of the safety lock lever 39 are two holes 42 that fits between the spindles 41 in the lever opening 38. Incorporated into the lever opening 38 and the safety lock lever 39 is a spring 40 that urges the lever into the locked position, requiring an effort to disengage the rack 11 and pawl 12 from the locked position, this prevents an accidental release of the tool 1 from an aerosol container.

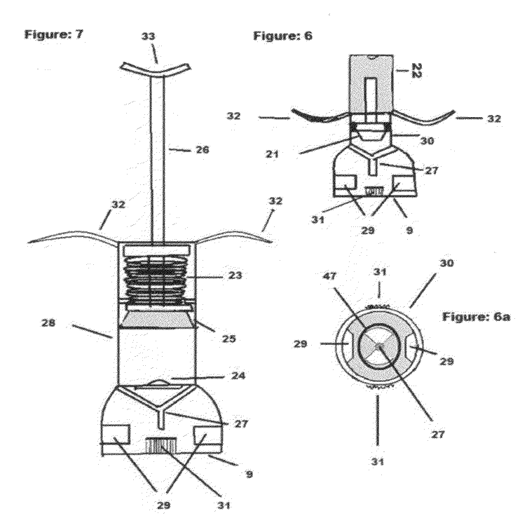

Represented in FIG. 6 is a spray actuator/nozzle assembly 2, this assembly 2 has a circular shaped female barbed receiver portion 9. This receiver portion 9 is clearly shown from the receiving end in FIG. 6a, the receiver portion 9 comprises of two female barbed connectors 29 on either side of the receiver 9 circumference. As the female receiver 9 is engaged with the male barbed connector 19 the female connectors 29 lock under the lip 46 of the male barbed connector 19. As the female connectors 29 lock under the lip 46 an O-ring 47 located in the receiver 9 seals against the tapered portion 48 of the male barbed connector 19. Between the female connectors 29 on either side of the receiver 9 circumference are two release points 31 that when squeezed toward each other spread the female connectors 29 apart to allow installing or releasing of a receiver 9 from the male barbed connector 19. As the female receiver 9 is snapped onto the male barbed connector 19 an appendage 27 in the center of the female receiver 9 engages the Schrader valve 20 releasing the flow of the aerosol product into the spray actuator/nozzle assembly 2. With the actuator/nozzle in place the operator can now use the tool 1 by using the finger grips 32 to depress the nozzle 22 releasing the containers content for it's intended purpose.

FIG. 7, illustrates an interchangeable hand operated pump 3 that is used in the case of an aerosol container void of pressure but with useable content. This pump attachment 3 is interchangeable with the actuator/nozzle assembly 2. It is comprised of a circular shaped female barbed receiver 9 and two female barbed connectors 29. This receiver portion 9 is clearly shown from the receiving end in FIG. 6a, the receiver portion 9 comprises of two barbed connectors 29 on either side of the receivers 9 circumference. As the female receiver 9 is engaged with the male barbed connector 19 the female connectors 29 lock under the lip 46 of the male barbed connector 19. As the female connectors 29 lock under the lip 46 an O-ring 47 located in the receiver 9 seals against the tapered portion 48 of the male barbed connector 19. Between the female connectors 29 on either side of the receivers 9 circumference are two release points 31 that when squeezed toward each other spread the female connectors 29 apart, for installing or releasing the receiver 9 from the male barbed connector 19. As the female receiver 9 is snapped onto the male barbed connector 19 an appendage 27 in the center of the female receiver 9 engages the Schrader valve 20. With the pump attachment 3 in place the operator can use the finger grips 32 to aid in depressing the pump shaft and thumb rest to pump pressure into the aerosol container.

Much of the forgoing describes a tool 1 that is made to receive replaceable and/or interchangeable components, it is obvious that this tool 1 could be conceived with a fixed spray actuator and nozzle eliminating a certain degree of complications as illustrated in FIG. 1. Changes, alterations, and modifications of this invention are only limited by the imagination, In light of the illustrations and descriptions of this invention the spirit, scope, principles, and it's contributing usefulness should be clearly understood.

I claim:

1. A hand-held aerosol salvage tool comprising of a first and second pivotally attached handles, each having a grip portion and a container receiving portion, said first and second handles are separately formed and pivotally attached by a hinged connection in the said receiving portions, each said grip portion being generally symmetrical and each said receiving portion being generally semi-circular, said hinge positioned predominately on the first handle receiving portion, giving said second handle a larger semi-circular receiving portion having a container piercing tube and gasket in fixed relation to the said second handle, projecting inwardly from the receiving portion of said handle, a tool having a barbed receiver as one element in relation to the said piercing tube projecting through to outer portion of said second handle opposite said piercing tube and said gasket, a tool comprising of a remotely interchangeable spray actuator/nozzle with evacuating means and pump with filling means, each removably fitting said tool in relation to said barbed receiver.

2. An aerosol salvage tool as set forth in claim 1 comprising of a spring co-acting with said hinge urging said first and second handles into an open position.

3. An aerosol salvage tool as set forth in claim 1 having said first and second handles comprising of a rack and pawl engaging and affecting a locking position for each closing adjustment of said tool as said handles are biased toward said closing positions.

4. An aerosol salvage tool as set forth in claim 1 having a said piercing member being a single element in relation to said barbed receiver.

5. An aerosol salvage tool as set forth in claim 1 having an interchangeable said actuator/nozzle with said evacuating means in relation to said barbed receiver.

6. An aerosol salvage tool as set forth in claim 1 having an interchangeable said pump with said filling means in relation to said barbed receiver.

7. An aerosol salvage tool as set forth in claim 2 wherein said first and second handle means are biased in an open position to allow insertion of a container therebetween.

8. An aerosol salvage tool as set forth in claim 3 having a secondary locking means in relation to said rack and said pawl.

9. An aerosol salvage tool as set forth in claim 4 having a valved flow controlling means in relation to said piercing tube and said barbed receiver.

10. An aerosol salvage tool as set forth in claim 4 comprising of a said barbed receiver having a male orientation in relation to said actuator/nozzle and said pump.

11. An aerosol salvage tool as set forth in claim 5 comprising of a said actuator/nozzle having a female orientation in relation to said.

12. An aerosol salvage tool as set forth in claim 6 comprising of a said pump having a female orientation in relation to said barbed receiver.
